(19) United States
(12) Patent Application Publication
(10) Pub. No.: US 2002/0122853 A1
(43) Pub. Date: Sep. 5, 2002

(54) Process and device for treating food products, such as vegetables

(75) Inventors: Jacques Bracquart, Renescure (FR); Daniel Pagniez, Renescure (FR); Laurent Dupont, Renescure (FR)

Correspondence Address: HARRISON & EGBERT, Suite 100, 1018 Preston St., Houston, TX, 77002, US

(73) Assignee: Bonduelle Societe Anonyme

(21) Appl. No.: 09/770,775

(22) Filed: Jan. 26, 2001

(51) Int. Cl. A23B 4/00

(52) U.S. Cl. 426/302; 426/615

(57) ABSTRACT

The invention involves a process for treating food products (5) such as, notably, vegetables, in which:

a stirring tank (1) that is at least partially filled with the products is driven at least in rotating on itself around a first axle (3) that is provided so that it is roughly horizontal,

a liquid or pasteous culinary preparation is introduced into this tank (1) in a manner so as to allow products (5) to be coated.

The invention involves a process and a device for treating food products such as, notably, vegetables.

However, though it is mainly planned for these applications, it can also be used with all other types of food products.

Currently, it known to present food products that are ready to use, accompanied with a sauce and/or a seasoning. They are packaged in two separate packages, possibly combined to be sold. They are mixed at the moment when the dish is prepared.

Such a solution has the disadvantage of multiplying the number of different packages. In addition, it leaves the dosage and the distribution of the sauce and/or the seasoning up to the user.

The goal of the invention presented here is to propose a process and a device for treating food products such as, notably, vegetables, which prevents the disadvantages cited above and makes it possible to present a food product accompanied by a sauce and/or a seasoning that has already been mixed.

Another goal of the invention is to propose a process and a device for treating food products such as, notably, vegetables, in which they can be coated with a sauce and/or a seasoning while diminishing the risk that the products are broken during the treatment.

Another goal of the invention is to propose a process and a device for food products such as, notably, vegetables which allows them to be frozen along with the sauce and/or the seasoning intended to accompany them.

Another goal of the invention is to propose a process and a device for treating food products such as, notably, vegetables, which allow an optimization of the cycle time.

Other goals and advantages of the invention presented appear in reading the description that follows, which is given as a guideline and is not intended to be restrictive.

The invention involves a process for treating food products such as, notably, vegetables, in which:

a stirring tank that is at least partially filled with the products, is driven at least in rotating on itself around a first axle that is provided so that it is roughly horizontal,

a liquid or pasteous culinary preparation is introduced into this tank in a manner so as to allow the products to be coated.

The invention also involves a device for implementing the treatment process described above for food products such as, notably, vegetables, consisting of at least:

a stirring tank that is designed to be at least partially filled with the products and to be driven in rotating on itself around a first axle is provided so that it is roughly horizontal,

mechanisms for introducing a liquid or pasteous culinary preparation into this tank in a manner so as to ensure that tie products are coated.

The invention is better understood in reading the following description, accompanied by the attached drawings which make an integral part of it and among which:

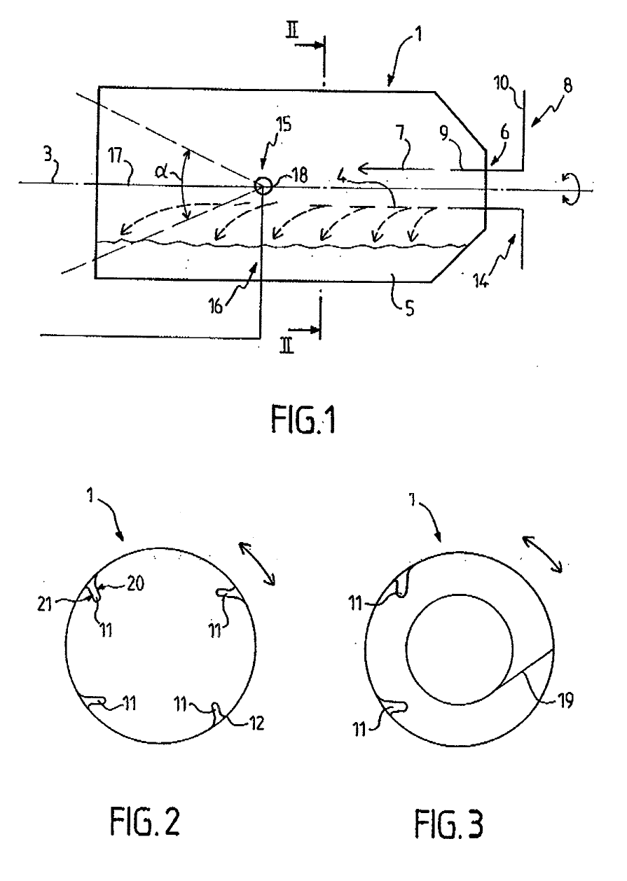

FIG. 1 shows, in a schematic diagram according to a diametric sectional view, an example of the implementation of the device according to the invention.

FIG. 2 is a section view made along the axis II-II shown in FIG. 1.

FIG. 3 shows an embodiment variation.

The invention involves a process for treating food products such as, notably, vegetables.

However, though it is mainly planned for these applications, it can also be used with all other types of food products.

As shown in FIG. 1, according to the invention, a stirring tank 1, at least partially filled with the products 5 to be treated, is driven in rotating on itself around a first axle 3 that is provided so that it is roughly horizontal, and a liquid or pasteous culinary preparation is introduced into this tank. It can if necessary also turn in either direction during stirring.

The food products are then progressively coated with a layer of the culinary preparation, product by product.

The tank 1 is, for example, roughly cylindrical and the first axle 3 is defined, notably, by the longitudinal axle of the cylinder. along an orientation that does not risk creating an accumulation of products at one end or the other of the longitudinal ends of the tank 1, during the treatment.

A slight oscillation in a vertical plane of this tank around this first axle can also be combined with its rotational movement. This involves, for example, oscillations of +1-5°.

The tank 1 is equipped with at least one opening 6 that allows the introduction of the product 5 and/or the culinary preparation. It is located, notably, at one of its longitudinal ends. It allows, in addition, if necessary, drainage after treatment.

The food products 5 are, as necessary, dressed, blanched, precooked, sterilized, pasteurized, deep-frozen, and/or measured out prior to being introduced into this tank 1.

The culinary preparation is constituted, notably, of a sauce, possibly loaded with particular solids. It is introduced into the tank 1, for example, at a temperature lower then 15°.

The filling is done, for example, until a minimum given height, for example, up to the halfway point.

According to an advantageous embodiment mode of the invention, the products 5 are made to roll onto themselves in the bottom of the tank 1. Thus, it is avoided that they are subjected to ruptures to the extent that are not broken during treatment.

If necessary, the products 5 could be kept in a same plane that is roughly perpendicular to the first axle 3. It is anticipated by this that the food products 5 will not be displaced along the direction of the longitudinal axle 3 during the rotation of the tank and are only mobile in a plane that itself is fixed relative to the first axle 3.

The culinary preparation is introduced by spraying, for example, along the arrow indicated 4, notably with a back-and-forth movement in a direction roughly parallel to the first axle 3.

Thus, this promotes the homogeneity of the distribution of the culinary preparation, and this is done more precisely when the food products 5 are held at a same level relative to the longitudinal axle 3.

In order to arrange the deep-frozen products for treatment, a refrigerating fluid can also be introduced into the tank 1, notably according to the arrow indicated 7.

This thus ensures a freezing of these products 5 and the culinary preparation during coating.

The refrigerating fluid is introduced, for example, by the opening 6. It is made up of, notably, liquid nitrogen which vaporizes instantly when it is introduced into the tank 1.

The different sequences of treatment are, in this case, the following: you introduce the food products 5 into the tank 1. When this is ended, you drive the tank 1 in rotation in order to allow a homogenous distribution of the products 5. You introduce the culinary preparation into the tank 1 while allowing it to turn in order to homogenize the coating, then you introduce the refrigerating fluid while keeping the tank 1 in rotation until the end of treatment.

A simultaneous introduction of the culinary preparation and the food products is also possible. It promotes the reduction of the rate of breakage while lowering the time of treatment and thus the number of turns made by the tank.

In order to obtain the desired coating thickness, you can if necessary successively repeat the stages of the introduction of the culinary preparation and the introduction of the refrigerating fluid.

The culinary preparation thus surrounds the previously coated layer, after this layer has been taken up in mass under the action of the refrigerating fluid.

In order to drain the tank, as explained below, you tip it, for example.

The invention also involves a device for implementing the process described above.

In addition to the stirring tank 1, provided in order to be filled at least partially with the products 5 and to be driven in rotation on itself around a first axle 3 that is roughly horizontal, the device according to the invention consist of at least mechanisms 8 for introducing the culinary preparation, liquid or pasteous, into the tank 1.

These mechanisms 8 for introducing the culinary preparation consist of, for example, a spraying nozzle 9 connected to a supply circuit 10 of a culinary preparation.

In a manner so as to allow the control of the distance at which the products 5 are sprayed with the culinary preparation, this supply circuit 10 is planned to be fitted to function under different pressures. You can thus obtain, as mentioned above, a back-and-forth movement for spraying along the longitudinal axle 3.

In order to do this, the supply circuit consists of, notably, a culinary preparation plug gauge connected to a volumetric pump with a frequency variation device and/or a mass flow meter, possibly controlled by each other.

In order to make the products 5 to roll over on themselves at the bottom of the tank, the tank is equipped on the inside, notably with a least one fixed blade 11, roughly straight, and arranged approximately along the direction of the first axle 3. One 12 of the edges of the blade 11 is affixed, for example, to the tank 1.

The blade 11 has, for example, two active sides 20, 21 that are asymmetrical, one soft, the other strong, used according to the food products treated.

The blade 11 is, notably of a relatively low height, for example, less than a quarter of the radius of the tank 1. Thus, you avoid ruptures in the path of the products 5.

1. Process for treating the food products (5) such as, notably, vegetables, in which:
a stirring tank (1) that is at least partially filled with the products, is driven at least in rotating on itself around a first axle (3) that is provided so that it is roughly horizontal,
a liquid or pasteous culinary preparation is introduced into this tank 1 in a manner so as to allow the products (5) to be coated.

2. Process according to claim 1, in which the products (5) are made to roll over onto themselves at the bottom of the tank (1).

3. Process according to claim 1, in which the products (5) are maintained in a same plane roughly perpendicular to the first axle (3).

4. Process according to any one of the claims 1 to 3, in which the culinary preparation is introduce by spraying by a back-and-forth movement in a direction roughly parallel to the first axle (3).

5. Process according to claim 1, in which a refrigerating fluid is additionally introduced into the tank (1) in a manner so as to ensure a freezing of the products (5) and the culinary preparation, during the coating.

6. Process according to claim 5, in which the steps for introducing the culinary preparation and introducing the refrigerating fluid are successively repeated in a manner so as to obtain the desired coating thickness.

7. Process according to claim 1, in which the tank (1) is emptied by tipping it.

8. Device for implementing the treatment process according to claim 1, for food products such as, notably, vegetables, consisting of at least:
a stirring tank (1) that is designed to be at least partially filled with the products (5) and to be driven in rotating on itself around a first axle (3) that is provided so that it is roughly horizontal,
mechanism (8) for introducing a liquid or pasteous culinary preparation into this tank (1) in a manner so as to ensure that the products (5) are coated.

9. Device according to claim 8, in which the mechanisms (8) for introducing the culinary preparation consist of a spraying nozzle (9) connected to a supply circuit (10) that is intended to function under different pressures, in a manner so as to allow the control of the distance at which the products are sprayed.

10. Device according to claim 8, in which the tank (1) is equipped on the inside with at least one fixed blade (11) that is roughly straight, arranged roughly in the direction of the first axle (3), and equipped with two asymmetrical active sides.
